(19) United States
(12) Patent Application Publication
(10) Pub. No.: US 2017/0087599 A1
(43) Pub. Date: Mar. 30, 2017

(54) METHOD FOR CLEANING GLASS FILM AND DEVICE FOR CLEANING GLASS FILM

(71) Applicant: Nippon Electric Glass Co., Ltd., Shiga (JP)

(72) Inventors: Shuji AKIYAMA, Shiga (JP); Kaoru MITSUGI, Shiga (JP); Koji NISHIJIMA, Shiga (JP)

(21) Appl. No.: 15/126,449

(22) PCT Filed: Mar. 18, 2015
(86) PCT No.: PCT/JP2015/058117

§ 371 Date: Sep. 15, 2016

(30) Foreign Application Priority Data
Mar. 20, 2014 (JP) 2014-058357

(51) Int. Cl. B08B 1/02; B08B 1/00

(52) U.S. Cl. CPC B08B 1/02; B08B 1/006

(57) ABSTRACT

Provided is a method of cleaning a surface of a glass film (1b) by causing roller brushes (2) arranged on a conveyance path to rotate in a direction reverse to a conveyance direction of a belt-shaped body (1) while conveying the belt-shaped body (1) that is obtained by coupling together end portions of the belt-shaped glass film (1b) and a leader (1a) by a sheet-shaped coupling member (1c) bonded on surfaces of the end portions. The method includes causing the roller brushes (2) to rotate forward in conformity with the conveyance direction of the belt-shaped body (1) when the coupling member (1c) passes through an arrangement region of the roller brushes (2).

### TECHNICAL FIELD

The present invention relates to a method of cleaning a glass film, and to an apparatus for cleaning a glass film.

### BACKGROUND ART

There is a demand to reduce weights of mobile devices such as smartphones and tablet personal computers that have been rapidly spread in recent years. Thus, thinning of glass substrates adopted for the devices has been promoted under current circumstances. In order to satisfy this demand, there has been developed a glass film obtained by thinning the glass substrate into a film (for example, having a thickness of 300 μm or less).

The glass film is extremely thin to have flexibility. Accordingly, for example, a belt-shaped glass film can be rolled around a roll core into a roll, and then accommodated as a glass roll. In addition, through use of the glass roll, a predetermined process (such as cleaning, film formation, or cutting) can be performed on the glass film by a so-called roll-to-roll method.

In the roll-to-roll method, as described in Patent Literature 1, an end portion of the belt-shaped glass film to be subjected to the process, and an end portion of a leader (such as a belt-shaped resin sheet) configured to lead the glass film to the roll core are coupled to each other by a sheet-shaped coupling member (such as a pressure-sensitive adhesive tape) bonded on surfaces of the end portions. That is, the leader and the glass film are connected in series through intermediation of the coupling member, thereby constructing a belt-shaped body.

While the glass film coupled to the leader in a state of the belt-shaped body is continuously unrolled from the roll core and conveyed, the process is performed on the glass film that is being conveyed. Then, the glass film subjected to the process is rolled around another roll core into a roll again, thereby being formed into a glass roll.

### CITATION LIST

Patent Literature 1: WO 2012/008529 A1

### SUMMARY OF INVENTION

### Technical Problem

Incidentally, when the process performed on the glass film by the roll-to-roll method involves a process of cleaning the glass film, there arise the following problems to be solved.

In a case of cleaning the glass film by the roll-to-roll method, as indicated by the blank arrows of FIG. 8a, a pair of rotary cleaning members 200 (such as roller brushes) arranged on a conveyance path of a belt-shaped body 100 is often rotated in a direction reverse to a conveyance direction of the belt-shaped body 100. In this manner, surfaces of a glass film 100b continuously passing through an arrangement region of the rotary cleaning members 200 are cleaned.

However, in this cleaning method, as illustrated in FIG. 8b, the rotary cleaning members 200 are rotated reversely. Thus, a coupling member 100c , which is bonded on a surface of an end portion of a leader 100a and a surface of an end portion of the glass film 100b to couple the end portions to each other, may be caught on the rotary cleaning members 200 to peel off the leader 100a.

When the above-mentioned problem arises, the leader 100a and the glass film 100b are separated from each other on the conveyance path of the belt-shaped body 100, with the result that a cleaning process cannot be performed on the glass film 100b . In addition, the glass film 100b is dragged by the coupling member 100c caught on the rotary cleaning members 200, thereby colliding against the rotary cleaning members 200. This may lead to a problem of breakage of the glass film 100b.

Further, when performing the cleaning process on the glass film, as illustrated in FIG. 9a, the end portion of the leader 100a and the end portion of the glass film 100b may be superposed on each other in a sheet thickness direction, and the coupling member 100c is bonded on the surfaces of the end portions to couple the end portions to each other. However, particularly in those cases, as illustrated in FIG. 9b, there arises a problem in that the glass film 100b is easily caught on the rotary cleaning members 200 so that the glass film 100b is easily broken.

Those problems arise even in other cases than the case of coupling the leader and the glass film to each other as described above. For example, those problems may always arise when the glass film coupled to the leader does not satisfy a predetermined length, and hence a plurality of sheet bodies (a leader and a glass film) including the glass film are coupled to each other as in a case of coupling the glass film to another glass film by the coupling member in order to extend an overall length of the glass film.

The present invention has been made in view of the above-mentioned circumstances, and has a technical object to prevent peeling-off of a coupling member configured to couple together a plurality of sheet bodies including a glass film, and to prevent breakage of the glass film when a rotary cleaning member cleans the glass film that is being conveyed.

### Solution to Problem

According to one embodiment of the present invention, which has been devised to achieve the above-mentioned object, there is provided a method of cleaning a glass film, comprising: cleaning a surface of a belt-shaped glass film by causing a rotary cleaning member arranged on a conveyance path to rotate in a direction reverse to a conveyance direction of a belt-shaped body while conveying the belt-shaped body that is obtained by coupling together end portions of a plurality of sheet bodies including the belt-shaped glass film by a sheet-shaped coupling member bonded on surfaces of the end portions; and causing the rotary cleaning member to rotate forward in conformity with the conveyance direction of the belt-shaped body when the sheet-shaped coupling member passes through an arrangement region of the rotary cleaning member.

According to this method, the rotary cleaning member is caused to rotate forward in conformity with the conveyance direction of the belt-shaped body when the coupling member passes through the arrangement region of the rotary cleaning member. Accordingly, it is possible to prevent occurrence of such a situation that the coupling member is caught on the rotary cleaning member to peel off, or that the glass film is caught on the rotary cleaning member to break.

In the above-mentioned method, it is preferred that from a moment immediately before the sheet-shaped coupling member passes through the arrangement region of the rotary cleaning member, the rotary cleaning member be caused to rotate forward. In this case, the description “a moment immediately before the coupling member passes through the arrangement region of the rotary cleaning member” means a state in which a forward end of the coupling member in the conveyance direction, which is approaching the rotary cleaning member, approaches an axis of the rotary cleaning member within a distance of from 5 mm to 200 mm along the conveyance path. It is preferred that the distance be set within a range of from 10 mm to 150 mm, and it is more preferred that the distance be set within a range of from 20 mm to 100 mm.

In this manner, the coupling member approaches the rotary cleaning member that has already rotated forward before passage of the coupling member. Accordingly, the coupling member can be securely prevented from being caught on the rotary cleaning member, and the glass film can be securely prevented from being caught on the rotary cleaning member. Therefore, it is possible to more suitably prevent peeling-off of the coupling member and breakage of the glass film.

In the above-mentioned method, it is preferred that a circumferential rotation speed of the rotary cleaning member during forward rotation be substantially equal to a conveyance speed of the belt-shaped body. In this case, the description “substantially equal to the conveyance speed of the belt-shaped body” means that the circumferential rotation speed of the rotary cleaning member during forward rotation is within a range of from 95% to 105% of the conveyance speed of the belt-shaped body.

In this manner, when the coupling member passes through the arrangement region of the rotary cleaning member, the rotary cleaning member rotates forward at the circumferential rotation speed substantially equal to the conveyance speed of the belt-shaped body. Thus, the rotary cleaning member functions as a conveyance roller configured to convey the belt-shaped body. Further, the rotary cleaning member can be prevented from applying an excessive force to the coupling member, with the result that the coupling member can be further suitably prevented from peeling off.

In the above-mentioned method, it is preferred that a detector configured to detect passage of the sheet-shaped coupling member be arranged on an upstream side of the conveyance path with respect to the arrangement region of the rotary cleaning member, and that the rotary cleaning member be caused to rotate forward based on a signal from the detector.

With this configuration, the detector can detect that the coupling member approaches the arrangement region of the rotary cleaning member, and the rotary cleaning member can be securely caused to rotate forward based on the signal from the detector. Accordingly, the present invention is more suitable for preventing peeling-off of the coupling member and breakage of the glass film.

In the above-mentioned method, it is preferred that the rotary cleaning member comprise a pair of rotary cleaning members arranged to sandwich the belt-shaped body in a thickness direction of the belt-shaped body.

With this configuration, when the glass film passes through the arrangement region of the rotary cleaning member, not only one surface of the glass film but also another surface thereof can be cleaned. Accordingly, cleaning of the glass film can be performed efficiently.

In the above-mentioned method, it is preferred that the belt-shaped glass film be unrolled from a first glass roll so as to pass through the arrangement region of the rotary cleaning member, and then be rolled into a second glass roll.

In this manner, the cleaning process can be performed on the glass film by the roll-to-roll method. Thus, cleaning of the glass film can be performed more efficiently.

According to one embodiment of the present invention, which has been devised to achieve the above-mentioned object, there is provided an apparatus for cleaning a glass film, the apparatus being configured to clean a surface of a belt-shaped glass film by causing a rotary cleaning member arranged on a conveyance path to rotate in a direction reverse to a conveyance direction of a belt-shaped body while conveying the belt-shaped body that is obtained by coupling together end portions of a plurality of sheet bodies including the belt-shaped glass film by a sheet-shaped coupling member bonded on surfaces of the end portions, the rotary cleaning member being configured to rotate forward in conformity with the conveyance direction of the belt-shaped body when a forward end of the sheet-shaped coupling member in the conveyance direction passes through an arrangement region of the rotary cleaning member.

With this configuration, it is possible to obtain the same operations and effects as those of the matters already described regarding the above-mentioned method of cleaning a glass film.

### Advantageous Effects of Invention

As described above, according to the present invention, it is possible to prevent peeling-off of the coupling member configured to couple together a plurality of sheet bodies including a glass film when the rotary cleaning member cleans the glass film that is being conveyed.

### BRIEF DESCRIPTION OF DRAWINGS

FIG. 1 is a vertical sectional side view for illustrating a method of cleaning a glass film and an apparatus for cleaning a glass film according to an embodiment of the present invention.

FIG. 2 is a plan view for illustrating the method of cleaning a glass film and the apparatus for cleaning a glass film according to the embodiment of the present invention.

FIG. 3 is a vertical sectional side view for illustrating the method of cleaning a glass film and the apparatus for cleaning a glass film according to the embodiment of the present invention.

FIG. 4 is a vertical sectional side view for illustrating the method of cleaning a glass film and the apparatus for cleaning a glass film according to the embodiment of the present invention.

FIG. 5 is a vertical sectional side view for illustrating the method of cleaning a glass film and the apparatus for cleaning a glass film according to the embodiment of the present invention.

FIG. 6 is a vertical sectional side view for illustrating the method of cleaning a glass film and the apparatus for cleaning a glass film according to the embodiment of the present invention.

FIG. 7 is a vertical sectional side view for illustrating a method of cleaning a glass film and an apparatus for cleaning a glass film according to another embodiment of the present invention.

FIG. 8a is a vertical sectional side view for illustrating a related-art method of cleaning a glass film.

FIG. 8b is a vertical sectional side view for illustrating the related-art method of cleaning a glass film.

FIG. 9a is a vertical sectional side view for illustrating the related-art method of cleaning a glass film.

FIG. 9b is a vertical sectional side view for illustrating the related-art method of cleaning a glass film.

### DESCRIPTION OF EMBODIMENTS

Now, an apparatus for cleaning a glass film and a method of cleaning a glass film according to an embodiment of the present invention are described with reference to the attached drawings. Note that, in the following embodiment, a case of cleaning a belt-shaped glass film by a roll-to-roll method is described by way of example.

First, description is made of a belt-shaped body to be used in the roll-to-roll method.

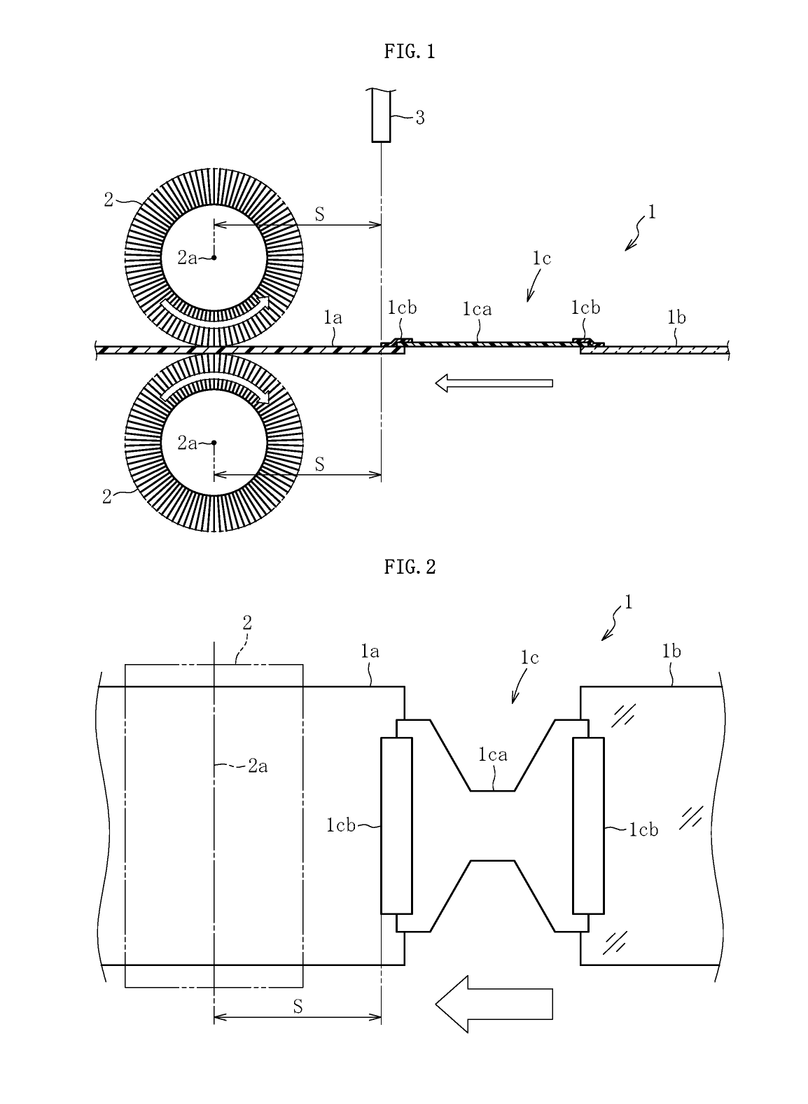

As illustrated in FIG. 1 and FIG. 2, a belt-shaped body 1 comprises a leader 1a configured to lead a glass film 1b to a roll core, the belt-shaped glass film 1b being an object to be cleaned, and a coupling member 1c configured to couple the leader 1a and the glass film 1b to each other. In the belt-shaped body 1, an end portion of the leader 1a and an end portion of the belt-shaped glass film 1b , which are opposed to each other, are coupled together by the sheet-shaped coupling member 1c bonded on upper surfaces of the end portions. In this way, the leader 1a and the glass film 1b are connected in series through intermediation of the coupling member 1c.

The leader 1a is a belt-shaped resin sheet, and has flexibility. The belt-shaped glass film 1b has a thickness of 300 μm or less, and has flexibility similarly to the leader 1a . In this case, it is preferred that the thickness of the glass film 1b be 200 μm or less, more preferably 100 μm or less, most preferably 50 μm or less. The coupling member 1c comprises a resin sheet body 1ca and two pressure-sensitive adhesive tapes 1cb. On the upper surface side of the belt-shaped body 1, the resin sheet body 1ca is stretched between the end portion of the leader 1a and the end portion of the glass film 1b . Further, along a longitudinal direction of the belt-shaped body 1, the resin sheet body 1ca comprises both end portions formed to become wider, and a center portion formed to become narrower. One of the two pressure-sensitive adhesive tapes 1cb is bonded so as to cover one end portion of the resin sheet body 1ca and the end portion of the leader 1a . Further, another one of the pressure-sensitive adhesive tapes 1cb is bonded so as to cover another end portion of the resin sheet body 1ca and the end portion of the glass film 1b.

Not only one longitudinal end portion (end portion illustrated in FIG. 1 and FIG. 2) of the glass film 1b but also another longitudinal end portion thereof (not shown) is coupled to the leader 1a through intermediation of the coupling member 1c . In other words, the leaders la and the glass film 1b are connected in series in the order of the leader 1a , the glass film 1b , and the leader 1a.

Next, the apparatus for cleaning a glass film is described.

As illustrated in FIG. 1 and FIG. 2, the apparatus for cleaning a glass film comprises, as main components, roller brushes 2 serving as rotary cleaning members arranged on a conveyance path of the belt-shaped body 1, and an optical sensor 3 serving as a detector configured to detect passage of the coupling member 1c . Further, the apparatus for cleaning a glass film is configured to perform a cleaning process on the glass film by the roll-to-roll method. That is, the apparatus for cleaning a glass film is configured to unroll the glass film 1b , which is coupled to the leader 1a through intermediation of the coupling member 1c , from a first glass roll so as to cause the glass film 1b in a laid posture to pass through an arrangement region of the roller brushes 2, and then roll the glass film 1b into a second glass roll.

The roller brushes 2 are arranged so as to be opposed to each other while sandwiching the belt-shaped body 1 in a thickness direction of the belt-shaped body 1. Each of the paired roller brushes 2 has a larger length along an axis 2a thereof than a width of the glass film 1b . Further, the roller brushes 2 are connected to a servomotor (not shown) being a power source for the roller brushes 2. Further, as indicated by the blank arrows of FIG. 1, the roller brushes 2 are controlled by the servomotor so as to rotate in, as a basic rotation direction, a direction reverse to a conveyance direction of the belt-shaped body 1.

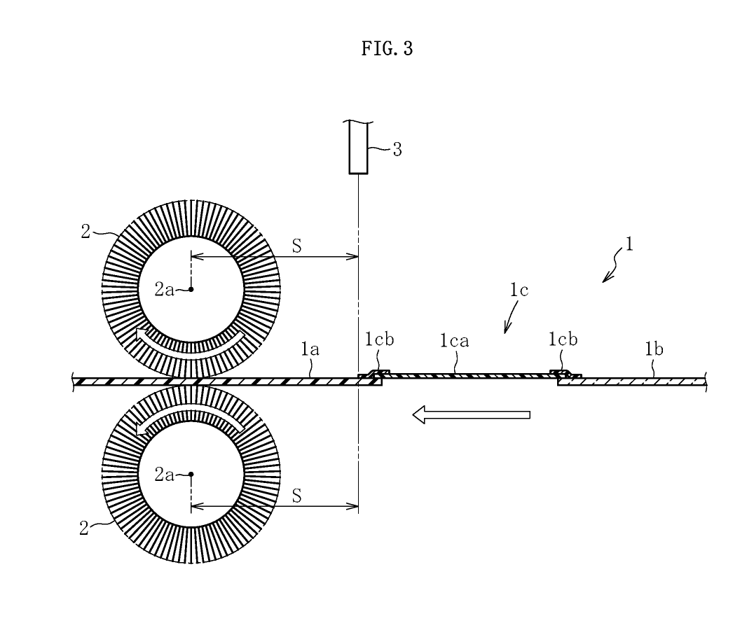

The sensor 3 is arranged at a position separated by a distance S from the axes 2a of the roller brushes 2 toward an upstream side of the conveyance path of the belt-shaped body 1. Further, when detecting that a forward end of the coupling member 1c in the conveyance direction (forward end of one of the pressure-sensitive adhesive tapes 1cb in the conveyance direction) passes directly below the sensor 3, the sensor 3 transmits a signal to the servomotor connected to the roller brushes 2. As illustrated in FIG. 3, after receiving the signal, the servomotor switches the direction of reverse rotation of the roller brushes 2 to a direction of forward rotation in conformity with the conveyance direction of the belt-shaped body 1. In this manner, from a moment immediately before the coupling member 1c passes through the arrangement region of the roller brushes 2, the roller brushes 2 start to rotate forward.

In this case, a timing of start of forward rotation of the roller brushes 2 is adjusted to a moment when the forward end of the coupling member 1c in the conveyance direction, which is approaching the roller brushes 2, approaches the axes 2a of the roller brushes 2 within an arbitrary distance of from 5 mm to 200 mm along the conveyance path. It is preferred that the arbitrary distance be set within a range of from 10 mm to 150 mm, and it is more preferred that the arbitrary distance be set within a range of from 20 mm to 100 mm. Further, this timing can be adjusted, for example, by changing the distance S between the sensor 3 and the axes 2a of the roller brushes 2. As a conveyance speed of the belt-shaped body 1 becomes higher, the distance S becomes longer. Further, a circumferential rotation speed of the roller brushes 2 during forward rotation is controlled to from 95% to 105% of the conveyance speed of the belt-shaped body 1. In addition, the conveyance speed of the belt-shaped body 1 is preferably from 0.1 m/min to 10 m/min, more preferably from 0.3 m/min to 5 m/min, still more preferably from 0.5 m/min to 3 m/min.

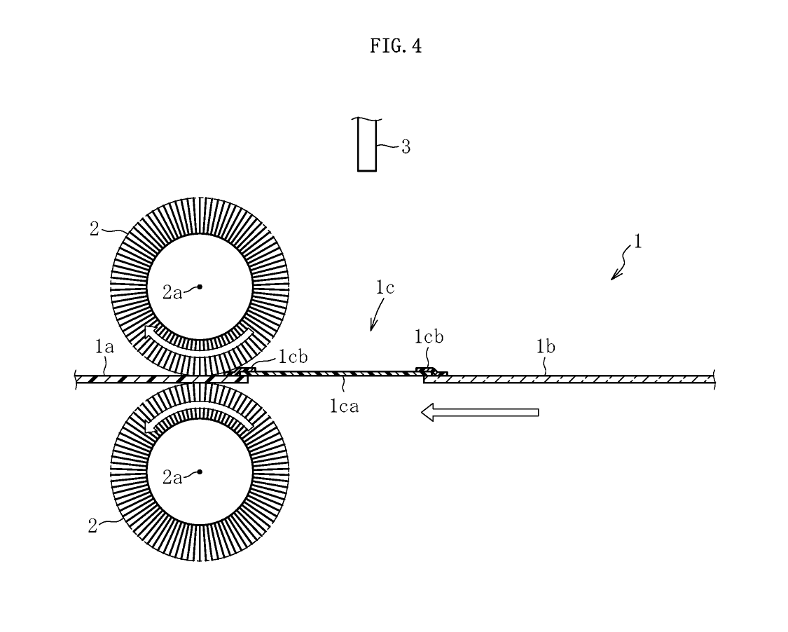

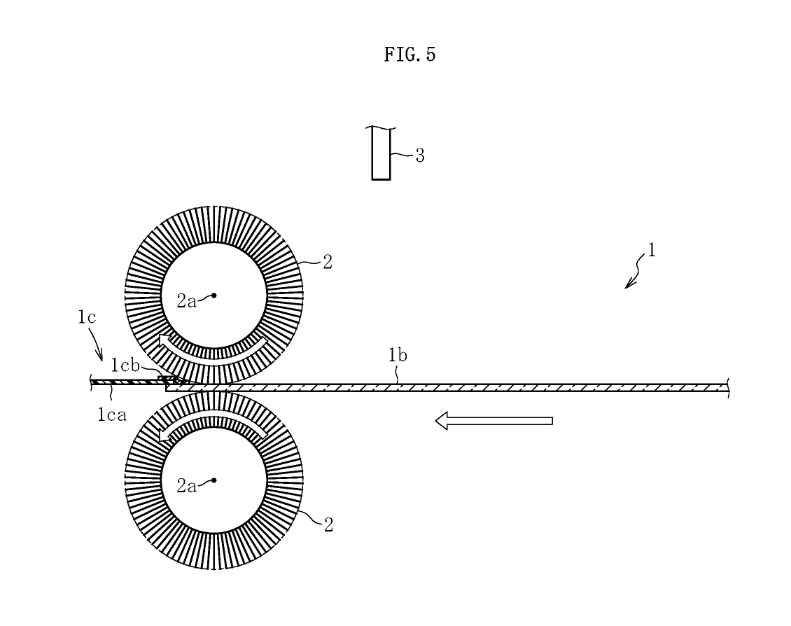

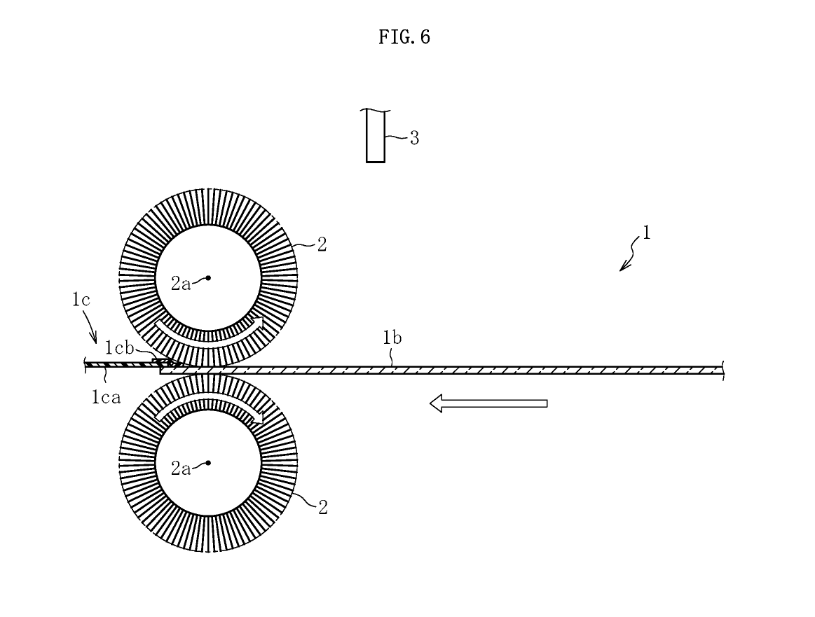

After the roller brushes 2 rotate forward until the coupling member 1c passes through the arrangement region of the roller brushes 2 overall along the conveyance direction as illustrated in FIG. 4 and FIG. 5, the rotation direction of the roller brushes 2 is returned again from the direction of forward rotation to the direction of reverse rotation as illustrated in FIG. 6. In this manner, the pair of roller brushes 2 starts to clean upper and lower surfaces of the glass film 1b.

In this case, the rotation direction of the roller brushes 2 is returned to the direction of reverse rotation after the servomotor receives the signal from the sensor 3 to cause the roller brushes 2 to continue rotating forward only for a certain time period. In this manner, the roller brushes 2 are controlled so as to rotate forward only during passage of an overall length of the coupling member 1c . The time period when the roller brushes 2 continue rotating forward can be adjusted in accordance with, for example, the distance S between the sensor 3 and the axes 2a of the roller brushes 2, the conveyance speed of the belt-shaped body 1, and the overall length of the coupling member 1c along the conveyance direction. That is, it is only necessary to adjust the time period so that the roller brushes 2 continue rotating forward only during a time period obtained by dividing a sum of the distance S and the overall length of the coupling member 1c by the conveyance speed of the belt-shaped body 1.

When the roller brushes 2 enter a final stage of cleaning the upper and lower surfaces of the glass film 1b , the leader 1a (not shown) following the glass film 1b approaches the arrangement region of the roller brushes 2. Then, regarding the coupling member 1c (not shown) coupling the glass film 1b and the following leader 1a to each other, when the forward end of the above-mentioned coupling member 1c in the conveyance direction passes directly below the sensor 3, the signal is transmitted from the sensor 3 to the servomotor. Thus, similarly to the above-mentioned case, the rotation direction of the roller brushes 2 is switched from the direction of reverse rotation to the direction of forward rotation.

Now, description is made of operations and effects of the method of cleaning a glass film using the above-mentioned apparatus for cleaning a glass film.

According to the method of cleaning a glass film, when the coupling member 1c passes through the arrangement region of the roller brushes 2, the roller brushes 2 rotate forward in conformity with the conveyance direction of the belt-shaped body 1. Accordingly, it is possible to prevent occurrence of such a situation that the coupling member 1c is caught on the roller brushes 2 to peel off, or that the glass film 1b is caught on the roller brushes 2 to break.

In this method, from the moment immediately before the coupling member 1c passes through the arrangement region of the roller brushes 2, the roller brushes 2 rotate forward. Accordingly, the coupling member 1c approaches the roller brushes 2 that have already rotated forward before the coupling member 1c passes through the arrangement region. In addition, even if switching from reverse rotation of the roller brushes 2 to forward rotation thereof is not smoothly performed so that a time lag arises during the switching, such a situation is less likely to occur that the coupling member passes through the arrangement region of the roller brushes 2 remaining rotating reversely. Thus, the effects of preventing peeling-off of the coupling member 1c and breakage of the glass film 1b are further enhanced.

When the coupling member 1c passes through the arrangement region of the roller brushes 2, the roller brushes 2 rotate forward at the circumferential rotation speed substantially equal to the conveyance speed of the belt-shaped body 1 (from 95% to 105% of the conveyance speed of the belt-shaped body 1). Accordingly, the roller brushes 2 function as conveyance rollers configured to convey the belt-shaped body 1. In addition, the roller brushes 2 can be prevented from applying an excessive force to the coupling member 1c . Therefore, the effects of preventing peeling-off of the coupling member 1c are still further enhanced.

The sensor 3 can detect that the coupling member 1c approaches the arrangement region of the roller brushes 2, and the roller brushes 2 can be securely caused to rotate forward based on the signal from the sensor 3. Accordingly, the present invention is suitable for preventing peeling-off of the coupling member 1c and breakage of the glass film 1b.

According to the method of cleaning a glass film, when the glass film 1b passes through the arrangement region of the roller brushes 2, it is possible to clean not only one of the upper and lower surfaces of the glass film 1b but also another one of the upper and lower surfaces. In addition, the cleaning process can be performed on the glass film 1b by the roll-to-roll method. Accordingly, cleaning of the glass film 1b can be performed efficiently.

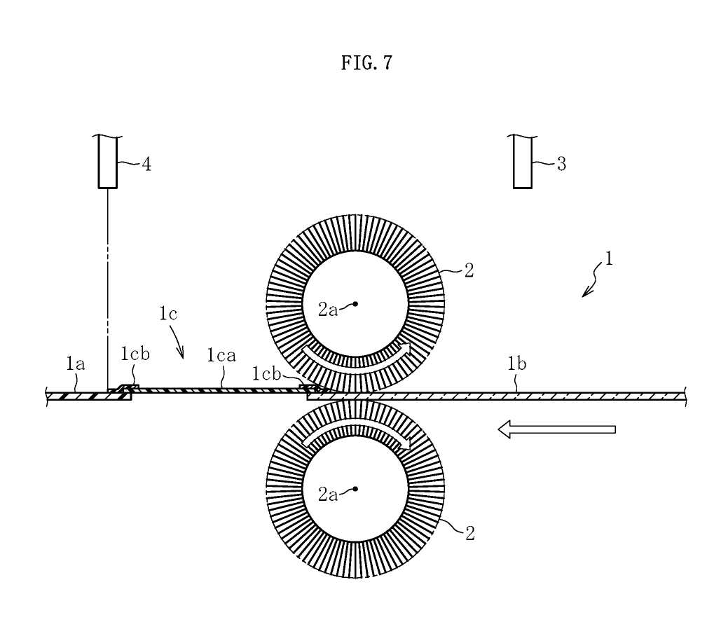

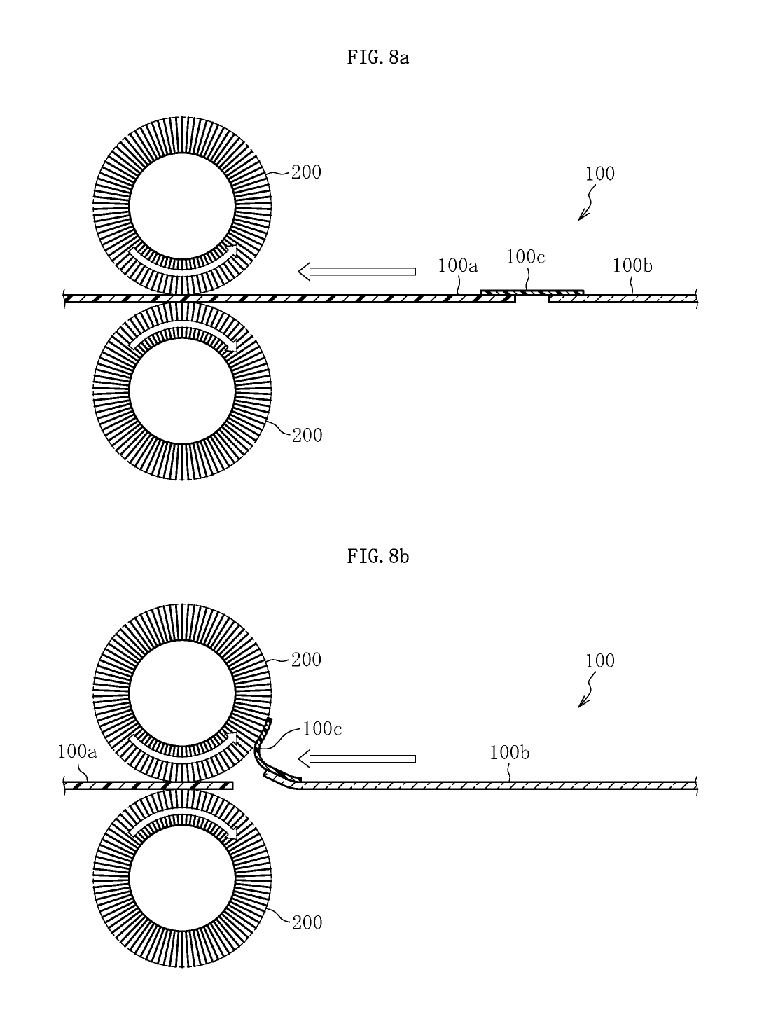

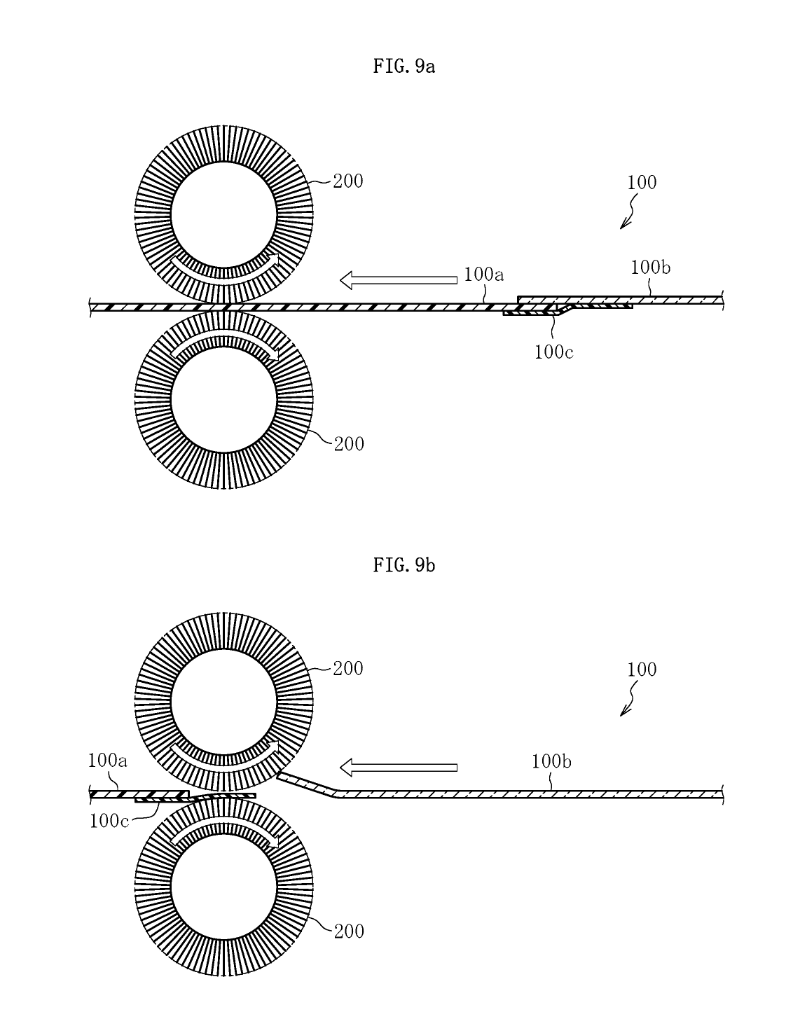

The apparatus for cleaning a glass film and the method of cleaning a glass film according to the present invention are not limited to the configuration or the mode described in the above-mentioned embodiment. In the above-mentioned embodiment, the rotation direction of the roller brushes is controlled to return to the direction of reverse rotation after the servomotor receives the signal from the sensor to cause the roller brushes to continue rotating forward only for a certain time period. However, for example, the rotation direction of the roller brushes may be controlled to return to the direction of reverse rotation in the following mode. That is, as illustrated in FIG. 7, a new optical sensor 4 is arranged on a downstream side of the conveyance path of the belt-shaped body 1 with respect to the roller brushes 2. When the sensor 4 detects that the coupling member 1c (the forward end of the coupling member 1c in the conveyance direction in FIG. 7) passes directly below the sensor 4, the sensor 4 may transmit a signal to the servomotor so that the rotation direction of the roller brushes 2 is returned to the direction of reverse rotation.

In the above-mentioned embodiment, the roller brushes are controlled so as to rotate in, as the basic rotation direction, the direction reverse to the conveyance direction of the belt-shaped body. That is, the roller brushes rotate reversely except during passage of the coupling member. However, as long as the roller brushes rotate forward during passage of the coupling member and rotate reversely during passage of the glass film, the roller brushes may rotate forward or stop during passage of the leader. Note that, the description “rotate forward during passage of the leader” herein means both a case of forward rotation of the roller brushes caused by power of the servomotor, and a case of forward rotation of the roller brushes caused only by friction between the leader and the roller brushes. Further, when the roller brushes are stopped during passage of the leader, it is not necessary to switch the rotation direction of the roller brushes from the direction of reverse rotation to the direction of forward rotation when the coupling member passes through the roller brushes. Accordingly, when the coupling member passes through the roller brushes, the roller brushes can be promptly started to rotate forward. In addition, when the roller brushes are caused to rotate forward during passage of the leader, the circumferential rotation speed of forward rotation of the roller brushes can be promptly changed to the speed substantially equal to the conveyance speed of the belt-shaped body when the coupling member passes through the roller brushes.

In the above-mentioned embodiment, the circumferential rotation speed of the roller brushes during forward rotation is controlled so as to be substantially equal to the conveyance speed of the belt-shaped body, but it is not always necessary that the circumferential rotation speed be equal to the conveyance speed. Even when the circumferential rotation speed is different from the conveyance speed, the effects of the present invention can be obtained. However, even when the circumferential rotation speed of the roller brushes during forward rotation is not substantially equal to the conveyance speed of the belt-shaped body, the circumferential rotation speed is preferably from 50% to 200% of the conveyance speed, more preferably from 80% to 150% of the conveyance speed, still more preferably from 90% to 120% of the conveyance speed. Further, in the above-mentioned embodiment, from a moment immediately before the coupling member passes through the arrangement region of the roller brushes, the roller brushes are caused to rotate forward. However, the present invention is not limited thereto. As long as the roller brushes rotate forward during passage of the coupling member, the effects of the present invention can be obtained. In addition, in the above-mentioned embodiment, only the pair of roller brushes is arranged along the conveyance path of the belt-shaped body, but a plurality of pairs of roller brushes may be arranged along the conveyance path.

In the above-mentioned embodiment, the roller brushes are used as the rotary cleaning member. In addition to the roller brushes, for example, polyurethane, melamine, polyvinyl acetate (PVA), rubber, and sponge formed into a roll shape maybe also used as the rotary cleaning member.

In the above-mentioned embodiment, the coupling member configured to couple the leader and the glass film to each other is constructed by the pressure-sensitive adhesive tapes and the resin sheet body, but the effects of the present invention are also obtained even in other cases than the case of coupling the leader and the glass film by the above-mentioned coupling member. As long as end portions of a plurality of sheet bodies including the glass film are coupled to each other by a sheet-shaped coupling member bonded on surfaces of the end portions, the effects of the present invention can be obtained even when the plurality of sheet bodies are coupled to each other in any way. For example, the effects of the present invention can be also obtained in a case of superposing an end portion of the leader and an end portion of the glass film on each other in a sheet thickness direction and then coupling the leader and the glass film together by bonding a pressure-sensitive adhesive tape on surfaces of the end portions (in this case, the pressure-sensitive adhesive tape constructs the coupling member). Polyethylene terephthalate (PET), polyether nitrile (PEN), polypropylene (PP), polyethylene (PE), polyvinyl chloride (PVC), nylon, or the like having an acrylic, rubber, or silicone pressure-sensitive adhesive may be used as the pressure-sensitive adhesive tape. PET, PEN, PP, PE, PVC, nylon, or the like may be used as the resin sheet body. Further, not only in a case of coupling the leader and the glass film to each other as in the above-mentioned embodiment, but also in a case of coupling glass films to each other by the coupling member, the effects of the present invention can be obtained. Further, in the above-mentioned embodiment, both of the upper and lower surfaces of the glass film are cleaned, but only one of the upper and lower surfaces may be cleaned. In addition, in the above-mentioned embodiment, the glass film is cleaned by the roll-to-roll method, but the effects of the present invention can be obtained in other methods. Further, in the above-mentioned embodiment, the glass film in a laid posture is cleaned, but the effects of the present invention can be also obtained even in a case of cleaning the glass film in an upright posture, and a case of cleaning the glass film in a posture oblique to a horizontal plane.

### REFERENCE SIGNS LIST

1 belt-shaped body
1a leader
1b glass film
1c coupling member
1ca resin sheet body
1cb pressure-sensitive adhesive tape
2 roller brush
2a axis
3 sensor
4 sensor
S distance between axis and sensor

1. A method of cleaning a glass film, comprising:
cleaning a surface of a belt-shaped glass film by causing a rotary cleaning member arranged on a conveyance path to rotate in a direction reverse to a conveyance direction of a belt- shaped body while conveying the belt-shaped body that is obtained by coupling together end portions of a plurality of sheet bodies including the belt-shaped glass film by a sheet-shaped coupling member bonded on surfaces of the end portions; and
causing the rotary cleaning member to rotate forward in conformity with the conveyance direction of the belt-shaped body when the sheet-shaped coupling member passes through an arrangement region of the rotary cleaning member.

2. The method of cleaning a glass film according to claim 1, wherein from a moment immediately before the sheet-shaped coupling member passes through the arrangement region of the rotary cleaning member, the rotary cleaning member is caused to rotate forward.

3. The method of cleaning a glass film according to claim 1, wherein a circumferential rotation speed of the rotary cleaning member during forward rotation is substantially equal to a conveyance speed of the belt-shaped body.

4. The method of cleaning a glass film according to claim 1,
wherein a detector configured to detect passage of the sheet-shaped coupling member is arranged on an upstream side of the conveyance path with respect to the arrangement region of the rotary cleaning member, and
wherein the rotary cleaning member is caused to rotate forward based on a signal from the detector.

5. The method of cleaning a glass film according to claim 1, wherein the rotary cleaning member comprises a pair of rotary cleaning members arranged to sandwich the belt-shaped body in a thickness direction of the belt-shaped body.

6. The method of cleaning a glass film according to claim 1, wherein the belt-shaped glass film is unrolled from a first glass roll so as to pass through the arrangement region of the rotary cleaning member, and then is rolled into a second glass roll.

7. An apparatus for cleaning a glass film, the apparatus being configured to clean a surface of a belt-shaped glass film by causing a rotary cleaning member arranged on a conveyance path to rotate in a direction reverse to a conveyance direction of a belt-shaped body while conveying the belt-shaped body that is obtained by coupling together end portions of a plurality of sheet bodies including the belt-shaped glass film by a sheet-shaped coupling member bonded on surfaces of the end portions,
the rotary cleaning member being configured to rotate forward in conformity with the conveyance direction of the belt-shaped body when the sheet-shaped coupling member passes through an arrangement region of the rotary cleaning member.
